(19) United States
(12) Patent Application Publication
(10) Pub. No.: US 2024/0226924 A1
(43) Pub. Date: Jul. 11, 2024

(54) MISTING DEVICE

(71) Applicant: Matthew Yates, Chandler, AZ (US)

(72) Inventor: Matthew Yates, Chandler, AZ (US)

(21) Appl. No.: 18/094,103

(22) Filed: Jan. 6, 2023

(51) Int. Cl. B05B 1/20; E04F 10/02; F24F 6/14

(52) U.S. Cl. CPC B05B 1/202; E04F 10/02; F24F 6/14

(57) ABSTRACT

A misting device, including a liquid pipe detachably connected to an external liquid source to receive at least one liquid therein, a plurality of nozzles disposed on at least a portion of the liquid pipe to mist the at least one liquid therefrom in response to the liquid pipe receiving the at least one liquid, and a shade removably connected to at least a portion of the liquid pipe to cover an area thereunder.

### BACKGROUND

### 1. Field

The present general inventive concept relates generally to heat relief, and particularly, to a misting device.

### 2. Description of the Related Art

During summer and/or in hot climate areas, it is important to remain in a shaded area to avoid overheating. Moreover, staying in the shade can reduce risk of heatstroke and dehydration.

Unfortunately, staying in the shade only removes exposure to sunlight. When outdoor temperatures are soaring, the shade will reduce the temperature, but it is often not significant enough for people who are susceptible to heat-related injuries. In other words, some people would still suffer from heatstroke while in the shade despite avoiding the sunlight.

Therefore, there is a need for a misting device that is integrated with the shade to decrease the temperature of the people under it.

### SUMMARY

The present general inventive concept provides a misting device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a misting device, including a liquid pipe detachably connected to an external liquid source to receive at least one liquid therein, a plurality of nozzles disposed on at least a portion of the liquid pipe to mist the at least one liquid therefrom in response to the liquid pipe receiving the at least one liquid, and a shade removably connected to at least a portion of the liquid pipe to cover an area thereunder.

The shade may include a covering body, and a plurality of nozzle receiving apertures disposed on at least a portion of the covering body to receive at least one of the plurality of nozzles therethrough.

The shade may further include a pipe receiving channel disposed within at least a portion of a perimeter on each edge of the covering body to receive the liquid pipe therein.

The covering body may facilitate movement of at least one of air and water therethrough.

The misting device may further include a plurality of cords detachably connected to the shade to suspend the shade from at least one of an external surface and an external structure.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a zoomed in view of a misting device, according to an exemplary embodiment of the present general inventive concept; and

FIG. 2 illustrates a top perspective view of the misting device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Misting Device 100
Liquid Pipe 110
Nozzles 120
Shade 130
Covering Body 131
Nozzle Receiving Apertures 132
Pipe Receiving Channel 133
Fastener Receiving Apertures 134
Fasteners 140
Cords 150

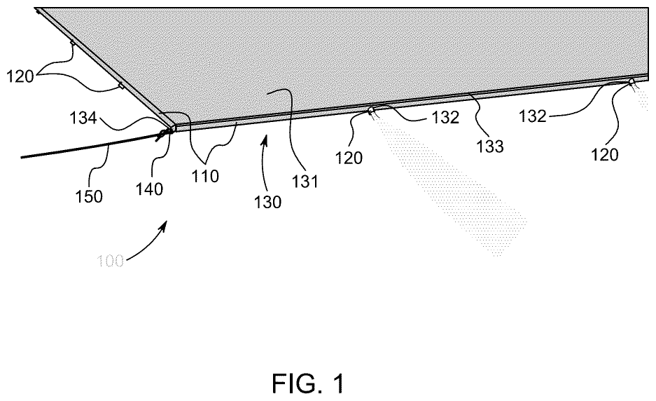

FIG. 1 illustrates a zoomed in view of a misting device 100, according to an exemplary embodiment of the present general inventive concept.

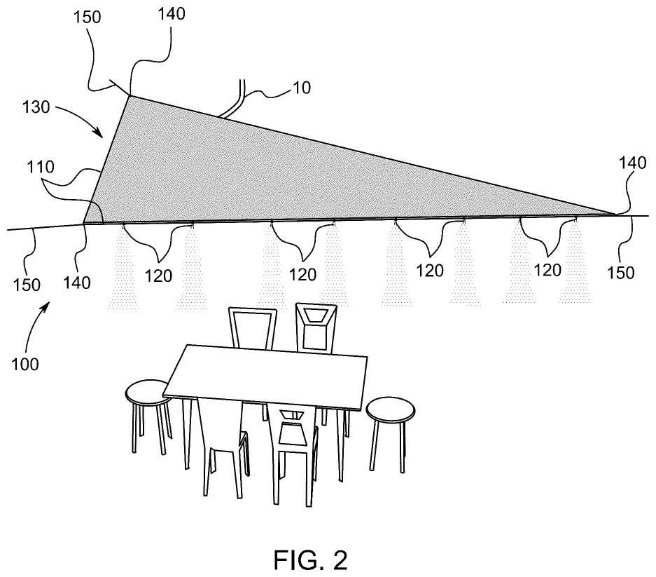

FIG. 2 illustrates a top perspective view of the misting device 100, according to an exemplary embodiment of the present general inventive concept.

The misting device 100 may be constructed from at least one of metal, plastic, wood, and rubber, etc., but is not limited thereto.

The misting device 100 may include a liquid pipe 110, a plurality of nozzles 120, a shade 130, a plurality of fasteners 140, and a plurality of cords 150, but is not limited thereto.

Although, the square flange bolt 110 is illustrated to be a bolt type fastener, the square flange bolt 110 may be at least one of a nail, a screw, a pin, a peg, a rivet, a threaded insert, and a threaded rod, etc., but is not limited thereto.

Referring to FIGS. 1 and 2, the liquid pipe 110 may have an elongate and cylindrical shape. However, the liquid pipe 110 may be rectangular, circular, pentagonal, hexagonal, heptagonal, octagonal, or any other shape known to one of ordinary skill in the art, but is not limited thereto. Additionally, the liquid pipe 110 may be arranged in any pattern. For example, referring again to FIG. 2, the liquid pipe 110 may be arranged in a triangular pattern.

The liquid pipe 110 may be detachably connected to an external liquid source 10. For example, the liquid pipe 110 may be detachably connected via a hose to a municipal water supply. As such, the liquid pipe 110 may receive at least one liquid (e.g., water) therein. The liquid pipe 110 may receive the at least one liquid in response to turning on a liquid supply (e.g., a water faucet).

Each of the plurality of nozzles 120 may include a pump and a power source (e.g., a power inlet, a battery), but is not limited thereto.

The plurality of nozzles 120 may be disposed on at least a portion of the liquid pipe 110. Moreover, each of the plurality of nozzles 120 may be distanced and/or separated from each other. Each of the plurality of nozzles 120 may dispense (i.e., mist, spray) the at least one liquid therefrom in response to the liquid pipe 110 receiving the at least one liquid therein using the pump. As such, the at least one liquid emitted from the plurality of nozzles 120 may decrease a temperature level of a user thereunder. Alternatively, the plurality of nozzles 120 may dispense the at least one liquid based on liquid pressure (e.g., water pressure) from the external liquid source 10.

It is important to note that the plurality of nozzles 120 misting the at least one liquid is different from spraying. Specifically, misting may create a cloud and/or a fog of liquid vapor while spraying will eject a concentrated stream of the at least one liquid.

The shade 130 may include a covering body 131, a plurality of nozzle receiving apertures 132, a pipe receiving channel 133, and a plurality of fastener receiving apertures 134, but is not limited thereto.

The covering body 131 may include a mesh, but is not limited thereto. Therefore, the covering body 131 may facilitate movement of air and/or water (e.g., rain) therethrough.

The covering body 131 may be removably connected to at least a portion of the liquid pipe 110. The covering body 131 may cover an area thereunder, such that the covering body 131 may prevent light from reaching the area. In other words, the covering body 131 may shade the area from the light. As such, the covering body 131 may decrease the temperature level of the user thereunder.

The plurality of nozzle receiving apertures 132 may be disposed on at least a portion of the covering body 131. A number of the plurality of nozzle receiving apertures 132 may correspond to a number of the plurality of nozzles 120. Each of the plurality of nozzle receiving apertures 132 may receive at least one of the plurality of nozzles 120 therethrough.

The pipe receiving channel 133 may be disposed within at least a portion of the covering body 131. More specifically, the pipe receiving channel 133 may be disposed within at least a portion of a perimeter on each edge of the covering body 131. Thus, the pipe receiving channel 133 may receive and/or store the liquid pipe 110 therein.

The plurality of fastener receiving apertures 134 may be disposed on at least a portion of each corner of the covering body 131. The plurality of fastener receiving apertures 134 may receive at least one fastener therein.

Each of the plurality of fasteners 140 may include a grommet, a hook, a clamp, a clasp, clip, a screw, a nail, a bolt, a nut, a washer, an adhesive (e.g., tape, glue), a magnet, and/or any combination thereof, but is not limited thereto.

Each of the plurality of fasteners 140 may be detachably connected to at least one of the plurality of fastener receiving apertures 134. The plurality of fasteners 140 may connect the covering body 131 to an external surface and/or an external structure (e.g., a building) via the plurality of fastener receiving apertures 134.

Each of the plurality of cords 150 may include a rope, a string, a twine, a wire, and/or any combination thereof, but is not limited thereto.

Each of the plurality of cords 150 may be detachably connected to at least one of the plurality of fasteners 140 and/or the covering body 131. Moreover, the plurality of cords 150 may connect the plurality of fasteners 140 and/or the covering body 131 to the external surface and/or the external structure. As such, referring again to FIG. 2, the covering body 131 may be suspended from the external surface and/or the external structure using the plurality of cords 150.

Therefore, the misting device 100 may decrease the temperature level of the user based on a combination of the plurality of nozzles 120 and/or the shade 130. Also, the misting device 100 may cool the user without requiring use of a shade and/or a mist separately.

The present general inventive concept may include a misting device 100, including a liquid pipe 110 detachably connected to an external liquid source 10 to receive at least one liquid therein, a plurality of nozzles 120 disposed on at least a portion of the liquid pipe 110 to mist the at least one liquid therefrom in response to the liquid pipe 110 receiving the at least one liquid, and a shade 130 removably connected to at least a portion of the liquid pipe 110 to cover an area thereunder.

The shade 130 may include a covering body 131, and a plurality of nozzle receiving apertures 132 disposed on at least a portion of the covering body 131 to receive at least one of the plurality of nozzles 120 therethrough.

The shade 130 may further include a pipe receiving channel 133 disposed within at least a portion of a perimeter on each edge of the covering body 131 to receive the liquid pipe 110 therein.

The covering body 131 may facilitate movement of at least one of air and water therethrough.

The misting device 100 may further include a plurality of cords 150 detachably connected to the shade 130 to suspend the shade 130 from at least one of an external surface and an external structure.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A misting device, comprising:
a liquid pipe detachably connected to an external liquid source to receive at least one liquid therein;
a plurality of nozzles disposed on at least a portion of the liquid pipe to mist the at least one liquid therefrom in response to the liquid pipe receiving the at least one liquid; and
a shade removably connected to at least a portion of the liquid pipe to cover an area thereunder.

2. The misting device of claim 1, wherein the shade comprises:
a covering body; and
a plurality of nozzle receiving apertures disposed on at least a portion of the covering body to receive at least one of the plurality of nozzles therethrough.

3. The misting device of claim 2, wherein the shade further comprises:
a pipe receiving channel disposed within at least a portion of a perimeter on each edge of the covering body to receive the liquid pipe therein.

4. The misting device of claim 2, wherein the covering body facilitates movement of at least one of air and water therethrough.

5. The misting device of claim 1, further comprising:
a plurality of cords detachably connected to the shade to suspend the shade from at least one of an external surface and an external structure.
